(19) United States
(12) Patent Application Publication
(10) Pub. No.: US 2010/0222504 A1
(43) Pub. Date: Sep. 2, 2010

(54) SILANE-SUBSTITUTED RAFT-REAGENTS AND SILANE-CROSS-LINKABLE POLYMERS

(75) Inventors: Oliver Minge, Munich (DE); Peter Ball, Emmerting (DE); Sabine Delica, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/681,980

(22) PCT Filed: Sep. 10, 2008
(86) PCT No.: PCT/EP08/61960

§ 371 Date: Apr. 7, 2010

(30) Foreign Application Priority Data
Oct. 8, 2007 (DE) 10 2007 000 833.5

(51) Int. Cl. C08L 83/06; C08G 77/06; C08G 77/14

(52) U.S. Cl. 524/588; 528/26; 528/25

(57) ABSTRACT

Addition polymers prepared in the presence of condensation-crosslinkable silyl-functional RAFT reagents are preparable in solid or liquid form with low polydispersion.

The present invention relates to silane-substituted RAFT reagents and to their use as an additional component in free-radically initiated polymerizations of ethylenically unsaturated monomers, and to the silane-crosslinkable polymers obtainable as a result, and also to their use as polymeric binders in, for example, formulations for coatings, adhesives or sealants.

For the production of coatings, adhesives or sealants, polymeric binders are used, with different compositions and in various formulations. Here, however, the lack of availability of polymeric binders which are of low viscosity and are fluid, and therefore convenient to process, continues to cause problems. It is common to formulate polymeric binders with addition of organic solvents, with those employed including not only inert solvents, such as acetic esters or butyl acetate, for example, but also reactive diluents, i.e., solvents which react with the binder in the course of the application. The use of formulations of this kind, however, leads to a burden on the working environment from organic solvents, and this necessitates corresponding safety measures, such as local air-exhaust systems, for example, which in turn entail costs. The use of solvent-containing formulations is subject to strict statutory impositions. Corresponding aqueous systems are often unsuitable, since such systems fall well below solvent-containing formulations in terms of their performance characteristics, such as water resistance, hydrophobicity or gloss, for example.

There is therefore a need for formulations for polymeric binders that contain no solvents at all (100% systems). For trouble-free processing, 100% systems ought to be of low viscosity under the usual conditions of storage and application, i.e., ought to have a viscosity of < about 150 000 mPas at the particular processing temperature.

Many 100% systems, however, are of sufficiently low viscosity only at high temperatures. 100% systems of this kind are known, among other things, as hotmelts. In other 100% systems that are of low viscosity at room temperature, however, the adhesion is based on mechanisms which are often inaccessible to particular applications, such as, for instance, UV activation, or systems based on cyanoacrylates, of the kind employed, for example, in common instant adhesives.

A further problem lies in the provision of polymeric binders with crosslinkable groups. On application, polymeric binders provided with crosslinkable groups crosslink typically to form films, thus giving coatings, adhesives or sealants having the desired hardness, insolubility or good adhesion. Common cross-linkable groups are, for example, silanes substituted by hydrolyzable radicals, such as silanes substituted by alkoxy radicals, for example. Silane-crosslinking polymers of this kind can be crosslinked in the presence of moisture through hydrolysis of the hydrolyzable groups and subsequent condensation, with formation of siloxane bridges.

The use of such silane-crosslinkable polymers as polymeric binders is known from, for example, U.S. Pat. No. 3,706,697, U.S. Pat. No. 4,526,930, EP-A 1153979, DE-OS 2148457, EP-A 327376, GB 1407827, DE-A 10140131 or EP-A 1308468; in the embodiments disclosed therein, the positions at which the crosslinkable silane groups are attached to the polymeric binder are undefined, i.e., are arbitrary.

Advantage is possessed in contrast by silane-crosslinkable polymers in which the crosslinkable silane groups are attached to the polymer at particular, defined positions, as is the case, for example, with silane-terminated polymers, where one or both ends of a polymer chain carry crosslinkable silane groups. As a consequence of the defined functionalization of the silane-terminated polymers, they crosslink to produce more uniform and more defined networks, and this has advantageous effects on the application properties and results, for example, in greater elasticity, stability or improved adhesion. Silane-terminated polymers are described in, for example, WO-A 06122684, WO-A 05100482, WO-A 05054390, US-AA 2003216536, U.S. Pat. No. 6,162,938, WO-A 9009403 or U.S. Pat. No. 6,001,946, and have to date been prepared by means of polymer-analogous reactions of polymers with silanes. The defined introduction of the silane functionalities in to the polymers, then, necessitates a separate reaction step. It would be more effective, in contrast, if the polymers were to be terminated with silanes in the course of their preparation. The linking of the silanes to the polymers is generally accomplished by means of condensation or addition reactions. For these reactions, however, the polymers are required to carry suitable functional groups. This is a given in the case, for example, of condensation polymers such as polyurethanes or polyesters. For polymers obtainable by free-radically initiated polymerization of ethylenically unsaturated monomers (vinyl polymers), this precondition is usually not met, and so silane-terminated polymeric binders of vinyl polymers are not accessible in this way.

Against this background, the problem which existed was that of providing silane-crosslinkable polymers which in the course of their preparation by free-radically initiated polymerization of ethylenically unsaturated monomers are terminated with silane groups at the polymer chain ends. Moreover, the silane-crosslinkable polymers ought to be suitable as polymeric binders for producing, for example, solvent-free 100% systems of low room-temperature viscosity, for adhesive, sealant or coating applications.

Surprisingly this problem has been solved by free-radically initiated polymerization of ethylenically unsaturated monomers in the presence of silane-substituted RAFT reagents.

The abbreviation RAFT stands for reversible addition-fragmentation chain transfer. RAFT reagents are species which add reversibly to polymerization-active free-radical species and at the same time release another polymerization-active free-radical species or else generate an intermediate which is capable in turn of releasing a polymerization-active free-radical species. RAFT reagents contain RAFT-reactive groups, such as, for example, thiocarbonylthio compounds which carry optionally substituted hydrocarbon radicals. The effect of implementing free-radically initiated polymerization reactions in the presence of RAFT reagents (RAFT reactions) is that the chains of the polymers obtainable in this way are terminated substantially with radicals which come from RAFT reagents. RAFT reactions, then, are free-radically initiated polymerization reactions of ethylenically unsaturated monomers that proceed in a controlled way. RAFT reactions and RAFT-reactive groups are known to the skilled person from, for example, G. Moad, E. Rizzardo, Aust. J. Chem. 2005, 58, 379-410. There is no description, however, of silane-substituted RAFT reagents. Accordingly, there is also no description of whether silane-substituted RAFT reagents are suitable for introducing silane functionalities into polymers.

The invention provides silane-substituted RAFT reagents of the general formulae

R¹ₙ(OR²)₃₋ₙSi-L¹-R^{f}—R³ (1a),

R¹ₙ(OR²)₃₋ₙSi-L¹-R^{f}-L²-Si(OR²)₃₋ₙR¹ₙ (1b), and

R¹ₙ(OR²)₃₋ₙSi-L¹-R^{f}-L²-R^{f}-L³-Si(OR²)₃₋ₙR¹ₙ (1c), where
R¹, R², and R³ each independently of one another are hydrogen atoms or monovalent C₁-C₂₀ hydrocarbon radicals which are optionally substituted by —CN, —NCO, —NR¹₂, —COOH, —COOR¹, —PO(OR¹)₂, -halogen, -acyl, -epoxy, —SH, —OH or —CONR¹₂,
and in which optionally one or more nonadjacent carbon atoms are replaced by groups —O—, —CO—, —COO—, —OCO—, —OCOO—, —CONR¹—, —S—, —CSS—, —CSO—, —COS— or —NR¹—, —N═ or —P═,
n in each case adopts integral values from 0 to 2,
L¹, L², and L³ each independently of one another are linear or cyclic, divalent C₁-C₂₀ hydrocarbon radicals which are optionally substituted by —CN, —NCO, —NR¹₂, —COOH, —COOR¹, —PO(OR¹)₂, -halogen, -acyl, -epoxy, —SH, —OH or —CONR¹₂,
and in which optionally one or more nonadjacent carbon atoms are replaced by groups —O—, —CO—, —COO—, —OCO—, —OCOO—, —CONR¹—, —S—, —CSS—, —CSO—, —COS— or —NR¹—, —N═ or —P═, and
R^{f} in each case is a divalent RAFT-reactive group.

The individual radicals R¹, R², and R³ and the groups L¹, L², and L³, and also R^{f} and n, in the formulae (1a), (1b), and (1c) may adopt their definition in each case independently of one another.

Preferred RAFT-reactive groups R^{f} are trithiocarbonate (—S—C(═S)—S—), xanthogenate (—O—C(═S)—S—) or dithiocarbamates (—NR¹—C(═S)—S—), where R¹ can stand for radicals meeting the definition above. Particularly preferred RAFT-reactive groups R^{f} are xanthogenate (—O—C(═S)—S—) or dithiocarbamates (—NR¹—C(═S)—S—), where R¹ can stand for a hydrogen atom or an optionally substituted cyclohexyl or phenyl radical.

Preferred radicals R¹ and R² in the formulae (1a), (1b), and (1c) are methyl, ethyl, phenyl or cyclohexyl.

Preferred radicals R³ are methyl, ethyl, phenyl, cyclohexyl, —CH₂—CO—OR¹ (acyl esters), and —CH(CH₃)CO—OR¹ (propionyl esters), with R¹ standing for the radicals indicated above. Particularly preferred radicals R³ are methyl, ethyl, acylmethyl ester, acylethyl ester, propionylmethyl ester, and propionylethyl ester.

Preferred values for n are 0 or 1.

Preferred groups L¹, L² or L³ are alkylene, bis(acyl)-dioxyalkylene, bis(acyl)-diaminoalkylene, bis-(propionyl)-dioxyalkylene, bis(propionyl)-diamino-alkylene, alkylene-S(C═O)—CH(R²)—, alkylene-N(R¹)—(C═O)—CH(R²)—, bis(alkylene-acyl)-dioxyalkylene, the respective alkylene units in each case independently of one another being preferably linear or cyclic, divalent C₁-C₁₀ hydrocarbon radicals optionally substituted by one or more radicals R¹, and R¹ and R² being radicals in accordance with the above definitions. Acyl stands for —C(R²)₂—(C═O)— units, where R² stands for radicals meeting the above definitions.

Particularly preferred groups L¹, L² or L³ are methylene, ethylene, propylene, 1,4-bis(acyl)-dioxybutylene, 1,5-bis(acyl)-dioxypentylene, 1,6-bis(acyl)-dioxyhexylene, 1,6-bis(acyl)-diaminohexylene, 1,4-bis-(propionyl)-dioxybutylene, 1,5-bis(propionyl)-dioxypentylene, 1,6-bis(propionyl)-dioxyhexylene, 1,6-bis-(propionyl)-diaminohexylene, acyl-N-cyclohexyl-propylene, acyl-N-cyclohexyl-methylene, acyl-N-phenyl-propylene, acyl-N-phenyl-methylene, —CH₂—CH₂—CH₂—S(C═O)—CH(CH₃)—, —CH₂—CH₂—CH₂—NH—(C═O)—CH(CH₃) —, —CH₂—NH—(C═O)—CH(CH₃)— or —(H₃C)CH—(O═C)—O—CH₂—CH₂—CH₂—CH₂—CH₂—CH₂—O—(C═O)—CH(CH₃)—.

In preferred silane-substituted RAFT reagents of the formulae (1a), (1b), and (1c), the individual radicals or groups and n are selected from the list containing n=0; R² is selected from the group encompassing methyl and ethyl; R³ is selected from the group encompassing methyl, ethyl, acylmethyl ester, propionylmethyl ester, acylethyl ester, and propionylethyl ester; L¹, L², and L³ in each case independently of one another are selected from the group encompassing methylene, propylene, alkylene-S(C═O)—CH(R²)—, alkylene-N(R¹)—(C═O)—CH(R²)—, acyl-N-cyclohexyl-propylene, acyl-N-cyclohexyl-methylene, acyl-N-phenyl-propylene, and acyl-N-phenyl-methylene; and R^{f} is selected from the group encompassing xanthogenate and dithiocarbamates, more particularly N-cyclohexyl-dithiocarbamates and N-phenyl-dithiocarbamates.

Particular preference is given to silane-substituted RAFT reagents of the formulae (1a) or (1b).

In preferred silane-substituted RAFT reagents of the formula (1a), R²=methyl, n=0, L¹=propylene, R^{f}=dithiocarbamate, and R³=acylmethyl ester; R²=ethyl, n=0, L¹=propylene, R^{f}=dithiocarbamate, and R³=acylmethyl ester; R²=methyl, n=0, L¹=propylene, R^{f}=dithiocarbamate, and R³=2-propionylmethyl ester; R²=methyl, n=0, L¹=methylene, R^{f}=dithiocarbamate, and R³=acylmethyl ester; R²=methyl, n=0, L¹=methylene, R^{f}=dithiocarbamate, and R³=2-propionylmethyl ester; R²=methyl, n=0, L¹=propylene, R^{f}═N-cyclohexyl-dithiocarbamate, and R³=acylmethyl ester; R²=ethyl, n=0, L¹=propylene, R^{f}═N-cyclohexyl-dithiocarbamate, and R³=acylmethyl ester; R²=methyl, n=0, L¹=propylene, R^{f}═N-cyclohexyl-dithiocarbamate, and R³=2-propionylmethyl ester; R²=methyl, n=0, L¹=methylene, R^{f}═N-cyclohexyl-dithiocarbamate, and R³=acylmethyl ester; R²=methyl, n=0, L¹=methylene, R^{f}═N-cyclohexyl-dithiocarbamate, and R³=2-propionylmethyl ester; R²=methyl, n=0, L¹=propylene, R^{f}═N-phenyl-dithiocarbamate, and R³=acylmethyl ester; R²=ethyl, n=0, L¹=propylene, R^{f}═N-phenyl-dithiocarbamate, and R³=acyl-methyl ester; R²=methyl, n=0, L¹=propylene, R^{f}═N-phenyl-dithiocarbamate, and R³=2-propionylmethyl ester; R²=methyl, n=0, L¹=methylene, R^{f}═N-phenyl-dithiocarbamate, and R³=acylmethyl ester; or R²=methyl, n=0, L¹=methylene, R^{f}═N-phenyl-dithiocarbamate, and R³=2-propionylmethyl ester, R²=methyl, n=0, L¹=—CH₂—CH₂—CH₂—S(C═O)—CH(CH₃)—, R^{f}=xanthogenate, and R³=ethyl; R²=methyl, n=0, L¹=—CH₂—CH₂—CH₂—NH—(C═O)—CH (CH₃)—, R^{f}=xanthogenate, and R³=ethyl; R²=methyl, n=0, L¹=—CH₂—NH—(C═O)—CH(CH₃)—, R^{f}=xanthogenate, and R³=ethyl.

In preferred silane-substituted RAFT reagents of the formula (1b), R²=methyl, n=0, L¹=propylene, R^{f}═N-cyclohexyl-dithiocarbamate, and L²=acyl-N-cyclohexyl-propylene; R²=methyl, n=0, L¹=methylene, R^{f}═N-cyclo-hexyl-dithiocarbamate, and L²=acyl-N-cyclohexyl-methylene; R²=methyl, n=0, L¹=propylene, R^{f}═N-phenyl-dithiocarbamate, and L²=acyl-N-phenyl-propylene; R²=methyl, n=0, L¹=methylene, R^{f}═N-phenyl-dithiocarbamate, and L²=acyl-N-phenyl-methylene; R²=methyl, n=0, L¹=propylene, R^{f}=-dithiocarbamate, and L²=acyl-N-phenyl-propylene; or R²=methyl, n=0, L¹=methylene, R^{f}=-dithiocarbamate, and L²=acyl-N-phenyl-methylene, R²=methyl, n=0, L¹=propylene, R^{f}═N-cyclohexyl-dithiocarbamate, and L²=acyl-S-propylene.

If corresponding silane-substituted synthetic building blocks known to the skilled person are employed, the silane-substituted RAFT reagents are obtainable by standard methods of organic synthetic chemistry; in other words, the silane-substituted RAFT reagents can be prepared, starting from corresponding silane-substituted synthetic building blocks, in a manner similar to that for RAFT reagents not substituted by silanes. Corresponding syntheses of RAFT reagents not substituted by silanes are described and cited in, for example, G. Moad, E. Rizzardo, Aust. J. Chem. 2005, 58, 379-410.

The silane-substituted RAFT reagents can be used as additional components in free-radically initiated polymerizations of ethylenically unsaturated monomers. In this way, in accordance with the RAFT reaction mechanism, polymers terminated with crosslinkable silane groups are formed. The silane-substituted RAFT reagents can be used in pure form or in the form of solutions in organic solvents.

The invention further provides silane-crosslinkable polymers obtainable by free-radically initiated polymerization of

A) one or more ethylenically unsaturated monomers selected from the group encompassing (meth)acrylic esters, vinyl esters, vinylaromatics, olefins, 1,3-dienes, vinyl halides, and vinyl ethers, and optionally

B) one or more ethylenically unsaturated auxiliary monomers, characterized in that the polymerization is carried out in the presence of one or more silane-substituted RAFT reagents.

Preferred ethylenically unsaturated monomers A) from the group of acrylic esters or methacrylic esters are esters of unbranched or branched alcohols having 1 to C atoms. Particularly preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate, and norbornyl acrylate. The most preferred are methyl acrylate, methyl methacrylate, n-butyl acrylate, n-butyl methacrylate, isobutyl acrylate, tert-butyl acrylate, 2-ethylhexyl acrylate, and norbornyl acrylate.

Preferred vinyl esters are vinyl esters of carboxylic acid residues having 1 to 15 C atoms. Particularly preferred are vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, an example being VeoVa9® or VeoVa10® (from Resolution). The most preferred are vinyl acetate, vinyl pivalate, vinyl laurate, and vinyl esters of α-branched monocarboxylic acids having 9 to 11 C atoms.

Preferred vinylaromatics are styrene, alpha-methylstyrene, the isomeric vinyltoluenes and vinyl-xylenes, and also divinylbenzenes. Styrene is particularly preferred.

A preferred vinyl ether is methyl vinyl ether.

Preferred olefins are ethene, propene, 1-alkylethenes, and polyunsaturated alkenes. Preferred dienes are 1,3-butadiene and isoprene. Of the olefins and dienes, ethene and 1,3-butadiene are particularly preferred.

A preferred vinyl halogen is vinyl chloride.

The most preferred as monomers A) are one or more monomers selected from the group encompassing vinyl acetate, vinyl esters of α-branched monocarboxylic acids having 9 to 11 C atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and 1,3-butadiene.

In the free-radically initiated polymerization it is also possible for two or more monomers A) and, if desired, two or more auxiliary monomers B) to be copolymerized, such as, preferably, n-butyl acrylate and 2-ethylhexyl acrylate and/or methyl methacrylate; styrene and one or more monomers from the group encompassing methyl acrylate, ethyl acrylate, propyl acrylate, n-butyl acrylate, 2-ethylhexyl acrylate; vinyl acetate and one or more monomers from the group encompassing methyl acrylate, ethyl acrylate, propyl acrylate, n-butyl acrylate, 2-ethylhexyl acrylate, and—optionally—ethylene; 1,3-butadiene and styrene and/or methyl methacrylate.

If desired it is possible to copolymerize in each case 0.1% to 20% by weight, based on the total weight of the monomers A), of ethylenically unsaturated auxiliary monomers B). It is preferred to use 0.5% to 2.5% by weight per auxiliary monomer B). In total, the sum of all auxiliary monomers B) may account for up to 20% by weight of the monomer mixture of A) and B); preferably there are in total less than 10% by weight of auxiliary monomers B). Examples of auxiliary monomers B) are ethylenically unsaturated monocarboxylic and dicarboxylic acids, preferably acrylic acid, meth-acrylic acid, fumaric acid, and maleic acid; ethylenically unsaturated carboxamides and carbonitriles, preferably acrylamide and acrylonitrile; monoesters and diesters of fumaric acid and maleic acid, such as the diethyl and diisopropyl esters, and also maleic anhydride, ethylenically unsaturated sulfonic acids and their salts, preferably vinyl-sulfonic acid, 2-acrylamido-2-methylpropanesulfonic acid. Further examples are precrosslinking comonomers such as polyethylenically unsaturated comonomers, examples being divinyl adipate, diallyl maleate, allyl methacrylate or triallyl cyanurate, or postcrosslinking comonomers, examples being acrylamidoglycolic acid (AGA), methacrylamidoglycolic acid methyl ester (MAGME), N-methylolacrylamide (NMA), N-methylolmethacrylamide, N-methylolallyl carbamate, alkyl ethers such as the isobutoxy ether or esters of N-methylolacrylamide, of N-methylolmethacrylamide, and of N-methylolallyl carbamate. Also suitable are epoxide-functional ethylenically unsaturated comonomers such as glycidyl methacrylate and glycidyl acrylate. Mention may also be made of ethylenically unsaturated monomers with hydroxyl groups or CO groups, examples being methacrylic and acrylic hydroxyalkyl esters such as hydroxyethyl, hydroxypropyl or hydroxybutyl acrylate or methacrylate, and also compounds such as diacetone-acrylamide and acetylacetoxyethyl acrylate or methacrylate. Mention may additionally be made of copolymerizable ethylenically unsaturated silanes, for instance vinylsilanes such as vinyltrimethoxysilane or vinyltriethoxysilane, or (meth)acrylosilanes, such as, for example, GENIOSIL® GF-31 (methacryloyloxypropyl-trimethoxysilane), GENIOSIL® XL-33 (methacryloyloxy-methyltrimethoxysilane), GENIOSIL® XL-32 (methacryloyloxymethyldimethylmethoxysilane), GENIOSIL® XL-34 (methacryloyloxymethylmethyldimethoxysilane), and GENIOSIL® XL-36 (methacryloyloxymethyltriethoxysilane) (GENIOSIL® is a trade name of Wacker Chemie).

The silane-substituted RAFT reagents and the monomers A), and also, where used, the monomers B), can be employed in any desired proportions in the polymerization.

The silane-crosslinkable polymers have at least one polymer chain end terminated with crosslinkable silane groups. When RAFT-reagents of the formula (1a) are used, the silane-crosslinkable polymers obtained are preferably polymers having one polymer chain end terminated with a crosslinkable silane group. When RAFT reagents of the formula (1b) or (1c) are employed, the silane-crosslinkable polymers obtained are preferably polymers which have two polymer chain ends terminated with crosslinkable silane groups. The polymer chain ends of the silane-crosslinkable polymers are terminated, for example, with the radicals R¹ₙ(OR²)₃₋ₙSi-L¹-R^{f}—, R¹ₙ(OR²)₃₋ₙSi-L¹-, —R^{f}-L²-Si(OR²)₃₋ₙR¹ₙ, -L²-Si(OR²)₃₋ₙR¹ₙ, —R^{f}-L²-R^{f}-L³-Si(OR²)₃₋ₙR¹ₙ, -L²-R^{f}-L³-Si(OR²)₃₋ₙR¹ₙ, —R^{f}-L³-Si(OR²)₃₋ₙR¹ₙ and/or -L³-Si(OR²)₃₋ₙR¹ₙ, depending on which of the silane-substituted RAFT reagents of the formulae (1a), (1b) and/or (1c) has been used.

The monomers A), and the weight fractions of the individual monomers A) and, where used, of the monomers B), are preferably selected such as to result in general in a glass transition temperature, Tg, of ≦60° C., preferably −50° C. to +60° C. The glass transition temperature Tg of the polymers can be determined in a known way by means of Differential Scanning Calorimetry (DSC). The Tg may also be calculated approximately in advance by means of the Fox equation. According to Fox T. G., Bull. Am. Physics Soc. 1, 3, page 123 (1956): it is the case that 1/Tg=x1/Tg1+x2/Tg2 + . . . +xn/Tgn, where xn is the mass fraction (% by weight/100) of the monomer n, and Tgn is the glass transition temperature, in kelvins, of the homopolymer of the monomer n. Tg values for homopolymers are listed in Polymer Handbook 2nd edition, J. Wiley & Sons, New York (1975).

The silane-crosslinkable polymers can also be present as blends with further polymers. Blends with further polymers comprise, in addition to the silane-cross-linkable polymers, preferably, in addition, silicones or homopolymers or copolymers based on monomers selected from the group encompassing vinyl esters, acrylic esters, methacrylic esters, acrylonitrile, vinyl chloride, vinyl ethers, olefins, and dienes, and also polyesters, polyamides, polyethers or polyurethanes. Particularly preferred blends comprise, in addition to the silane-crosslinkable polymers, as further polymers, silicones, vinyl chloride polymers, methacrylic ester polymers, acrylic ester polymers, styrene polymers, vinyl acetate-vinyl chloride copolymers or ethylene-vinyl acetate copolymers. These further polymers are preferably likewise silane-crosslinkable.

The invention further provides a process for preparing silane-crosslinkable polymers obtainable by free-radically initiated polymerization of

A) ethylenically unsaturated monomers selected from the group encompassing (meth)acrylic esters, vinyl esters, vinylaromatics, olefins, 1,3-dienes, vinyl halides, and vinyl ethers, and

B) optionally ethylenically unsaturated auxiliary monomers, characterized in that the polymerization is carried out in the presence of one or more silane-substituted RAFT reagents.

The silane-crosslinkable polymers are accessible by the bulk, suspension, emulsion or solution polymerization process.

Preferred organic solvents for the solution polymerization process have low values for transfer constants. Transfer constants are rate constants which indicate the rate of transfer of a growing polymer chain to—for example—the solvent. Transfer constants are listed in, for example, Polymer Handbook, J. Wiley, New York, 1979. Particularly preferred organic solvents have transfer constants which at 40° C., relative to the monomer system to be polymerized, are smaller by a factor of 2×10⁴, most preferably by a factor of 1×10⁴. Examples of preferred solvents are hexane, heptane, cyclohexane, ethyl acetate, butyl acetate or methoxypropyl acetate, and also methanol or water.

The preparation of the silane-crosslinkable polymers in accordance with the familiar heterophase techniques of suspension, emulsion or miniemulsion polymerization takes place in aqueous medium (cf., e.g., Peter A. Lovell, M. S. El-Aasser, “Emulsion Polymerization and Emulsion Polymers” 1997, John Wiley and Sons, Chichester). Preference is given to a polymerization in bulk, in organic solution or in aqueous suspension. Bulk polymerization has the advantage that the silane-crosslinkable polymers are obtained in the form of 100% systems. In aqueous suspension polymerization, the silane-crosslinkable polymers may be obtained, advantageously, in the form of granules.

The reaction temperatures are preferably 0° C. to 150° C., more preferably 20° C. to 130° C., most preferably 30° C. to 120° C. The polymerization may be carried out batchwise or continuously, with inclusion of all or some constituents of the reaction mixture in the initial charge, with partial inclusion in the initial charge and subsequent metering of individual constituents of the reaction mixture, or by the metering method, without an initial charge. All of the metered feeds are made preferably at the rate at which the respective component is consumed. Particular preference is given to a process in which the silane-substituted RAFT reagents are included in the initial charge, and the remaining constituents are metered in.

The polymerization is initiated by means of the customary initiators or redox initiator combinations. Examples of initiators are the sodium, potassium, and ammonium salts of peroxodisulfuric acid, hydrogen peroxide, tert-butyl peroxide, tert-butyl hydroperoxide, potassium peroxodiphosphate, tert-butyl peroxopivalate, cumene hydroperoxide, tert-butyl peroxobenzoate, isopropylbenzene monohydroperoxide, and azobisisobutyronitrile. The stated initiators are used preferably in amounts of 0.01% to 4.0% by weight, based on the total weight of the monomers A) and B), or in amounts of less than 20 mol %, based on the RAFT reagent employed. Redox initiator combinations used are aforementioned initiators in conjunction with a reducing agent. Suitable reducing agents are sulfites and bisulfites of monovalent cations, an example being sodium sulfite, the derivatives of sulfoxylic acid, such as zinc or alkali metal formaldehyde-sulfoxylates, an example being sodium hydroxymethanesulfinate, and ascorbic acid. The amount of reducing agent is preferably 0.15% to 3% by weight of the monomers A) and B) employed. In addition it is possible for small amounts to be introduced of a metal compound which is soluble in the polymerization medium and whose metal component is redox-active under the polymerization conditions, being based, for example, on iron or on vanadium. Particularly preferred initiators are tert-butyl peroxopivalate, and tert-butyl peroxobenzoate, and also the peroxide/reducing-agent combinations ammonium persulfate/sodium hydroxymethanesulfinate and potassium persulfate/sodium hydroxymethanesulfinate. An overview of further suitable initiators in addition to the representatives just described is found in the “Handbook of Free Radical Initiators”, E. T. Denisov, T. G. Denisova, T. S. Pokidova, 2003, Wiley.

The number-average polymer masses Mₙ of the silane-crosslinkable polymers obtainable in these ways is dependent on the proportion of the monomers A) and, where used, of the monomers B) to the silane-substituted RAFT reagents during the polymerization. Reducing the fraction of silane-substituted RAFT reagents relative to the monomers A) and, where used, monomers B) leads to corresponding silane-crosslinkable polymers having higher number-average polymer masses Mₙ.

In contrast, increasing the fraction of silane-substituted RAFT reagents relative to the monomers A) and, where used, monomers B) leads to corresponding silane-crosslinkable polymers having lower number-average polymer masses Mₙ. Since the silane-substituted RAFT reagents and the monomers A) and also, where used, the monomers B) can be used in any desired proportions in the polymerization, the silane-crosslinkable polymers are obtainable with any desired number-average polymer masses Mₙ.

As compared with conventional free-radically initiated polymerization reactions, the process of the invention, by the RAFT reaction mechanism, produces silane-crosslinkable polymers having a narrow molecular weight distribution. The molecular weight distribution can be expressed by means of the polydispersity index (PDI), which is the ratio of the polymer masses M_{w}/Mₙ of a polymer. The silane-crosslinkable polymers preferably have a PDI of 3.0 to 1.0, more preferably of 2.5 to 1.0, even more preferably of 2.0 to 1.0, very preferably of 1.5 to 1.0, and most preferably between 1.5 to 1.1.

In accordance with the process of the invention, therefore, silane-crosslinkable polymers are obtainable which have the number-average polymer masses Mₙ typical of polymerization reactions, but narrow molecular weight distributions.

One of the factors determining the viscosity of polymers is their polymer mass. Polymers with a relatively high polymer mass in general have a higher viscosity as compared with corresponding polymers having a relatively low polymer mass. In accordance with the process of the invention, given an appropriate selection of the reaction parameters, silane-crosslinkable polymers are obtainable in the form of solids and as liquids having any desired viscosities; in other words, both high-viscosity and low-viscosity silane-crosslinkable polymers are obtainable.

As a consequence of their preparation by means of RAFT reactions, the silane-crosslinkable polymers carry the silane groups at the chain ends of the polymers, and hence are distinguished by a defined structure which is known to result in advantageous performance properties, such as a higher elasticity, stability or improved adhesion, for example.

In order to improve the performance properties it is possible for further additives to be added to the silane-crosslinkable polymers. Examples of such additives are one or more solvents; film-forming assistants; pigment wetting agents and dispersants; and surface effect additives. With these surface effect additives it is possible to obtain textures such as hammer finish texture or orange peel texture; antifoams; substrate wetting agents; flow control agents; adhesion promoters; release agents; surfactants or hydrophobic additives.

The silane-crosslinkable polymers are suitable, for example, for use as polymeric binders in the field of coatings, adhesives or sealants. In these contexts, the silane-crosslinkable polymers may be used in pure form or as a constituent of corresponding formulations. The silane-crosslinkable polymers are obtainable with viscosities in line with the requirements imposed on binders for 100% systems for coatings, adhesives or sealants. For use as low-viscosity polymeric binders in 100% systems, the silane-crosslinkable polymers have viscosities preferably of ≦150 000 mPas, more preferably of 1000 mPas to 100 000 mPas.

Preferred adhesive applications for the silane-crosslinkable polymers are, for example, the use of the silane-crosslinkable polymers as woodblock flooring adhesives or general-purpose adhesives. Preferred sealant applications include the use of the silane-crosslinkable polymers for jointing ceramics, wood or stone. Preferred coating applications include the use of the silane-crosslinkable polymers in transparent varnishes or sealing varnishes for coating glass, wood, paper or plastics. Furthermore, the silane-cross-linkable polymers can also be used as nonvolatile plasticizers in plastics compositions, for instance PVC, polyacrylates or silicones.

The examples which follow serve for detailed illustration of the invention and should in no way be understood as a limitation.

### EXAMPLES

In the examples below, all amounts in % by weight are based on the total weight of the individual components of the composition in question, the pressures are 0.10 MPa (abs.), and the temperatures are 20° C., unless any other indications are made in the particular case.

Preparation of the Silane-Substituted RAFT Reagents:

### Example 1

### RAFT Reagent 1

A solution of mercaptopropyltrimethoxysilane (0.04 mol, 7.5 ml) and triethylamine (0.04 mol, 5.55 ml) in 30 ml of THF was admixed dropwise at room temperature, with stirring, with 2-bromopropionyl bromide (0.04 mol, 4.2 ml) in 2 ml of THF. The mixture was stirred at room temperature for 2 hours more, after which precipitated salts were removed by filtration. Potassium ethyl xanthogenate (0.04 mol, 6.41 g) was added and the mixture was stirred at room temperature for 6 hours. The precipitate formed was filtered off, and THF was removed under reduced pressure. The silane-substituted RAFT reagent of the formula below was obtained in the form of a yellow oil.

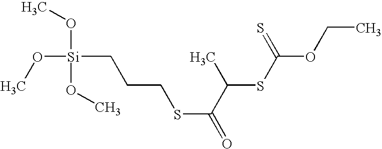

### Example 2

### RAFT Reagent 2

A solution of aminopropyltrimethoxysilane (0.04 mol, 7.5 ml) and triethylamine (0.04 mol, 5.55 ml) in 30 ml of THF was admixed dropwise at room temperature, with stirring, with 2-bromopropionyl bromide (0.04 mol, 4.2 ml) in 2 ml of THF. The mixture was stirred at room temperature for 2 hours more, after which precipitated salts were removed by filtration. Potassium ethyl xanthogenate (0.04 mol, 6.41 g) was added and the mixture was stirred at room temperature for 6 hours. The precipitate formed was filtered off, and THF was removed under reduced pressure. The silane-substituted RAFT reagent of the formula below was obtained in the form of a yellow oil.

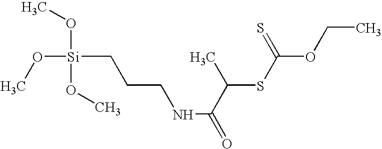

### Example 3

### RAFT Reagent 3

A solution of aminomethyltrimethoxysilane (0.04 mol, 7.5 ml) and triethylamine (0.04 mol, 5.55 ml) in 30 ml of THF was admixed dropwise at room temperature, with stirring, with 2-bromopropionyl bromide (0.04 mol, 4.2 ml) in 2 ml of THF. The mixture was stirred at room temperature for 2 hours more, after which precipitated salts were removed by filtration. Potassium ethyl xanthogenate (0.04 mol, 6.41 g) was added and the mixture was stirred at room temperature for 6 hours. The precipitate formed was filtered off, and THF was removed under reduced pressure. The silane-substituted RAFT reagent of the formula below was obtained in the form of a yellow oil.

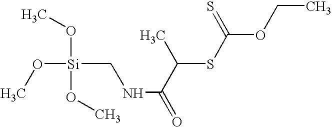

### Example 4

### RAFT Reagent 4

1,6-Hexanediol (0.02 mol, 2.36 g) and triethylamine (0.044 mol, 1.1 equivalents, 4.44 g) were introduced in 20 ml of THF cooled to 0° C. Added dropwise with stirring over the course of 5 minutes was bromo-propionyl bromide (0.044 mol, 1.1 equivalents, 9.50 g) in solution in 5 ml of THF. The mixture was stirred at room temperature for 4 hours. Subsequent removal of precipitated salts by filtration gave an organic solution of intermediate 1.

In a parallel batch, mercaptopropyltrimethoxysilane (0.02 mol, 3.93 g) was added slowly dropwise to a solution of 1,1,3,3-tetramethylguanidine (0.02 mol, 2.32 g) in 25 ml of carbon disulfide. The mixture was stirred at room temperature for four hours. A phase separation occurred, the upper phase containing intermediate 2, which is isolated.

Finally, intermediate 1 and intermediate 2 in a molar ratio of 1:2 were stirred in 10 ml of THF at room temperature for 4 hours. Precipitated salts were removed by filtration, and the solvent was removed under reduced pressure. The silane-substituted RAFT reagent of the following formula was obtained in the form of a deep-orange oil.

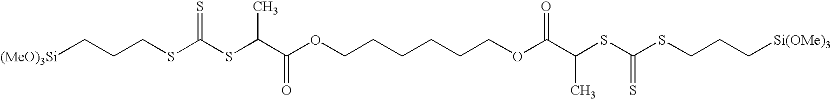

### Example 5

### RAFT Reagent 5

A solution of N-cyclohexylaminomethyltrimethoxysilane (0.04 mol, 7.5 ml) and triethylamine (0.04 mol, 5.55 ml) was added dropwise at room temperature, with stirring, with 2-bromopropionyl bromide (0.04 mol, 4.2 ml) in 2 ml of THF. The mixture was stirred at room temperature for 2 hours more, and then precipitated salts were removed by filtration. This gave intermediate A.

In a separate batch, N-cyclohexylaminomethyltrimethoxysilane (0.04 mol, 7.5 ml) and triethylamine (0.04 mol, 5.55 ml) were admixed with carbon disulfide CS₂ (0.04 mol, 6.41 g) and the mixture was stirred at room temperature for 6 hours. Intermediate A was added to the resulting suspension, which was stirred at room temperature for 4 hours. The precipitated salts were removed by filtration and volatile constituents were removed on a rotary evaporator (40° C., 40 mbar), to give the silane-substituted RAFT reagent of the following formula in the form of a yellow oil.

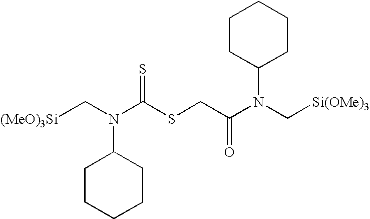

Preparation of the Silane-Crosslinkable Polymers:

Batch Process:

A stirred tank equipped with double-wall condenser, evaporative condenser, and stirrer was charged under a nitrogen atmosphere, in accordance with the details in Table 1, with the respective silane-substituted RAFT reagent, the respective monomers, and 0.2 equivalent of initiator, based on the silane-substituted RAFT reagent, and the batch was then held at the particular indicated temperature for a time of 8 hours.

Semibatch Process:

A stirred tank equipped with double-wall condenser, evaporative condenser, and stirrer was charged under a nitrogen atmosphere, in accordance with the details in Table 2, with, where appropriate, the respective silane-substituted RAFT reagent, together with 10% by weight of the respective, total amount of monomer used, and 10% by weight of the respective, total amount of initiator used, and this initial charge was heated to the particular indicated temperature. Following onset of the reaction, the remaining amount of monomer and also the remaining amount of initiator were metered in, in each case via a metering pump, over the course of 4 hours. A total of 0.2 mole equivalents of initiator was used, based on the respective RAFT reagent. After the end of the metered feed, stirring was continued for 4 hours at the temperature indicated.

From Tables 1 and 2 it is evident that the silane-crosslinkable polymers (Examples 6 to 19), relative to polymers (comparative examples 1 and 2) not prepared by polymerization in the presence of RAFT reagents, are characterized by low polydispersity indices, i.e., by narrow molecular weight distributions. Moreover, the procedure of the invention makes it possible to obtain polymers having very low molecular masses (e.g., Example 8) and also polymers having high molecular masses (e.g., Example 18), each with narrow, low polydispersity indices. Furthermore, by the process of the invention, it is also possible to obtain silane-crosslinkable polymers having very low viscosities (e.g., Example 14).

Testing of the Silane-Crosslinkable Polymers:

### Example 20

The silane-crosslinkable polymers from Example 6 and Example 12, respectively, were each admixed with 1.5% by weight of a 2M methanolic solution of dibutyltin dilaurate, and coated out onto a glass plate using a bar coater having a gap width of 120 μm. The resulting film was crosslinked under standard conditions in accordance with DIN50014 for one day. In each case, a homogeneous, transparent, tack-free film which adhered strongly to the glass plate and had elastic properties was obtained. Elasticity of this kind is characteristic of films obtained by crosslinking polymers whose crosslinkable groups are located at the polymer chain ends.

TABLE 1
Preparation of silane-crosslinkable polymers by the batch process:

| | RAFT | Monomer^{a)} | | Temperature | Mₙ^{d)}) | | Aggregate | Viscosity |
|---|---|---|---|---|---|---|---|---|
| Example | reagent | (equivalents)^{b)} | Initiator^{c)} | [° C.] | [g/mol] | PDI^{e)} | state^{f)} | [mPas]^{g)} |
| 6 | 1 | VAc (10) | AIBN | 70 | 1233 | 1.22 | liquid | 580 |
| 7 | 1 | VAc (30) | TBPV | 60 | 2953 | 1.19 | solid | — |
| 8 | 2 | VAc (10) | AIBN | 70 | 1215 | 1.47 | liquid | 560 |
| 9 | 2 | VAc (30) | TBPV | 60 | 2935 | 1.50 | solid | — |
| 10 | 3 | VAc (50) | AIBN | 70 | 4673 | 1.05 | solid | 1980 |
| 11 | 4 | VeoVa10 (10) | TBPV | 60 | 1814 | 1.22 | solid | — |

^{a)}VAc: vinyl acetate; VL: vinyl laurate; VeoVa9: vinyl neononanoate; VeoVa10: vinyl neodecanoate
^{b)}Equivalents based on the respective RAFT reagent
^{c)}AIBN: azobisisobutyronitrile; TBPV: tert-butyl perpivalate
^{d)}determined by means of gel permeation chromatography
^{e)}PDI: polydispersity index
^{f)}under standard conditions in accordance with DIN50014
^{g)}cone/plate viscometer at angular velocity of 20 s⁻¹ and temperature of 30° C.

TABLE 2
Preparation of silane-crosslinkable polymers by the semibatch process:

| | RAFT | Monomer^{a)} | | Temperature | Mₙ^{d)}) | | Aggregate | Viscosity |
|---|---|---|---|---|---|---|---|---|
| Example | reagent | (equivalents) | Initiator^{c)} | [° C.] | [g/mol] | PDI^{e)} | state^{f)} | [mPas]^{g)} |
| 12 | 1 | VL (25)^{b)}, | AIBN | 70 | 6268 | 1.33 | liquid | 6 |
| | | VAc (25)^{b)} | | | | | | |
| 13 | 1 | VL (5)^{b)}, | TBPV | 60 | 5600 | 1.27 | liquid | 85 |
| | | VAc (45)^{b)} | | | | | | |
| 14 | 1 | VeoVa9 (25)^{b)}, | TBPV | 60 | 7100 | 1.65 | liquid | 2 |
| | | VAc (25)^{b)} | | | | | | |
| 15 | 2 | VAc (468)^{b)} | AIBN | 70 | 42397 | 1.47 | solid | — |
| 16 | 3 | VAc (580)^{b)} | TBPV | 60 | 52666 | 1.47 | solid | — |
| 17 | 3 | VAc (760)^{b)} | AIBN | 70 | 68851 | 1.23 | solid | — |
| 18 | 4 | VAc (860)^{b)} | AIBN | 70 | 76900 | 1.17 | solid | — |
| 19 | 5 | VAc (100)^{b)} | AIBN | 60 | 9226 | 1.43 | solid | — |
| C1 | — | VAc, VL | AIBN | 70 | 10097 | 2.70 | solid | — |
| | | (in 1:1 molar ratio) | | | | | | |
| C2 | — | VAc, VL | TBPV | 60 | 20160 | 2.90 | solid | — |
| | | (in 1:1 molar ratio) | | | | | | |

^{a)}VAc: vinyl acetate; VL: vinyl laurate; VeoVa9: vinyl neononanoate; VeoVa10: vinyl neodecanoate
^{b)}Equivalents based on the respective RAFT reagent
^{c)}AIBN: azobisisobutyronitrile; TBPV: tert-butyl perpivalate
^{d)}determined by means of gel permeation chromatography
^{e)}PDI: polydispersity index
^{f)}under standard conditions in accordance with DIN50014
^{g)}cone/plate viscometer at angular velocity of 20 s⁻¹ and temperature of 30° C.

1.-10. (canceled)

11. A silane-crosslinkable polymer prepared by free-radically initiated polymerizing
A) one or more ethylenically unsaturated monomers comprising (meth)acrylic esters, vinyl esters, vinylaromatics, olefins, 1,3-dienes, vinyl halides, and vinyl ethers, and optionally
B) one or more ethylenically unsaturated auxiliary monomers other than monomers A), wherein the polymerization is carried out in the presence of one or more silane-substituted RAFT reagents of the formulae
R¹ₙ(OR²)₃₋ₙSi-L¹-R^{f}-L²-Si(OR²)₃₋ₙR¹ₙ (1b), or
R¹ₙ(OR²)₃₋ₙSi-L¹-R^{f}-L²-R^{f}-L³-Si(OR²)₃₋ₙR¹ₙ (1c), where
R¹ and R² each independently of one another are hydrogen atoms or monovalent C₁-C₂₀ hydrocarbon radicals optionally substituted by —CN, —NCO, —NR¹₂, —COOH, —COOR¹, —PO(OR¹)₂, -halogen, -acyl, -epoxy, —SH, —OH or —CONR¹₂,
and in which optionally one or more nonadjacent carbon atoms are replaced by groups —O—, —CO—, —COO—, —OCO—, —OCOO—, —CONR¹—, —S—, —CSS—, —CSO—, —COS— or —NR¹—, —N═or —P═,
n is an integral value from 0 to 2,
L¹, L², and L³ each independently of one another are linear or cyclic, divalent C₁-C₂₀ hydrocarbon radicals optionally substituted by —CN, —NCO, —NR¹₂, —COOH, —COOR¹, —PO(OR¹)₂, -halogen, -acyl, -epoxy, —SH, —OH or —CONR¹₂,
and in which optionally one or more nonadjacent carbon atoms are replaced by groups —O—, —CO—, COO—, —OCO—, —OCOO—, —CONR¹—, —S—, —CSS—, —CSO—, —COS— or —NR¹—, —N═ or —P═, and
R^{f} is a divalent RAFT-reactive group.

12. The silane-crosslinkable polymer of claim 11, wherein the silane-crosslinkable polymers have at least one polymer chain end terminated with crosslinkable silane groups.

13. The silane-crosslinkable polymer of claim 11, wherein the silane-crosslinkable polymers have a polydispersity index (PDI) of 3.0 to 1.0.

14. The silane-crosslinkable polymer of claim 11, wherein the silane-crosslinkable polymers have viscosities of <150,000 mPas.

15. A process for preparing a silane-crosslinkable polymer of claim 11, comprising a free-radically initiated polymerizing
A) ethylenically unsaturated monomers comprising (meth)acrylic esters, vinyl esters, vinylaromatics, olefins, 1,3-dienes, vinyl halides, and vinyl ethers, and
B) optionally ethylenically unsaturated auxiliary monomers other than monomers A),
wherein polymerizing is carried out in the presence of one or more silane-substituted RAFT reagents of the formulae
R¹ₙ(OR²)₃₋ₙSi-L¹-R^{f}-L²-Si(OR²)₃₋ₙR¹ₙ (1b), or
R¹ₙ(OR²)₃₋ₙSi L¹-R^{f}-L²-R^{f}-L³-Si(OR²)₃₋ₙR¹ₙ (1c), where
R¹ and R² each independently of one another are hydrogen atoms or monovalent C₁-C₂₀ hydrocarbon radicals which are optionally substituted by —CN, —NCO, —NR¹₂, —COOH, —COOR¹, —PO(OR¹)₂, -halogen, -acyl, -epoxy, —SH, —OH or —CONR¹₂,
and in which one or more nonadjacent carbon atoms are optionally replaced by groups —O—, —CO—, —COO—, —OCO—, —OCOO—, —CONR¹—, —S—, —CSS—, —CSO—, —COS— or —NR¹—, —N═ or —P═,
n is an integral value from 0 to 2,
L¹, L², and L³ each independently of one another are linear or cyclic, divalent C₁-C₂₀ hydrocarbon radicals which are optionally substituted by —CN, —NCO, —NR¹₂, —COOH, —COOR¹, —PO(OR¹)₂, -halogen, -acyl, -epoxy, —SH, —OH or —CONR¹₂,
and in which one or more nonadjacent carbon atoms are optionally replaced by groups —O—, —CO—, —COO—, —OCO—, —OCOO—, —CONR¹—, —S—, —CSS—, —CSO—, —COS— or —NR¹—, —N═ or —P═, and
R^{f} in each case is a divalent RAFT-reactive group.

16. A coating, adhesive, or sealant, comprising a silane-crosslinkable polymer. of claim 11.

17. In a plastics composition containing a plasticizer, the improvement comprising including as at least one plasticizer, a silane-crosslinkable polymer of claim 11.
